(19) United States
(12) Patent Application Publication
(10) Pub. No.: US 2012/0001757 A1
(43) Pub. Date: Jan. 5, 2012

(54) CONTAINER ELECTRONIC SEAL DEVICE WHICH CAN BE SELECTIVELY LOCKED AND UNLOCKED USING EXTERNAL MEMORY AND METHOD OF OPERATING THE SAME

(75) Inventors: Sea-Hee JUNG, Busan (KR); Hyun-Chul KIM, Busan (KR); Hyun-Chel LEE, Busan (KR); Jae-Hoon KONG, Busan (KR); Hye-Jin LEE, Busan (KR); Ho-Jun SON, Busan (KR); Sang-Gun KU, Busan (KR)

(73) Assignees: Sea-Hee JUNG, Busan (KR); DH TECHNOLOGY, INC., Busan (KR); Hyun-Chul KIM, Busan (KR)

(21) Appl. No.: 12/953,675

(22) Filed: Nov. 24, 2010

(30) Foreign Application Priority Data
Jul. 2, 2010 (KR) 10-2010-0063893

(51) Int. Cl. E05B 45/06; E05B 47/00; E05B 65/00

(52) U.S. Cl. 340/542; 70/91

(57) ABSTRACT

A container electronic seal device and a method of operating the container electronic seal device are provided. The container electronic seal device is installed on a door locking rod and a lock handle provided in a container door. The apparatus includes a body unit, a locking arm unit, and an electronic parts unit. The body unit is disposed around part of the door locking rod and part of the lock handle, and is provided with a through hole, a guide opening, and an access port. The locking arm unit rotates and fastens the lock handle inserted into the guide opening of the body unit. The electronic parts unit selectively performs locking and unlocking depending on whether a security authentication file of the external memory is normal and monitors illegitimate opening. The container electronic seal device is selectively locked and unlocked using the external memory storing a security authentication file.

### CROSS-REFERENCE TO RELATED APPLICATION

This application claims the benefit under 35 U.S.C. 119(a) of Korean Patent Application No. 10-2010-0063893, filed on Jul. 2, 2010, the entire disclosure of which is incorporated herein by reference for all purposes.

### BACKGROUND

1. Field

The present invention relates generally to a container electronic seal device which can be selectively locked and unlocked using external memory and a method of operating the container electronic seal device, and, more particularly, to a container electronic seal device, which allows external memory storing a security authentication file including a password to be inserted and connected and selectively performs normal locking and normal unlocking depending on whether the security authentication file of the external memory is normal, and a method of operating the container electronic seal device.

2. Description of the Related Art

In general, box-type containers which are used to efficiently and economically transport large, medium or small-sized freight are used to transport general freight and special freight easily because of there being no requirement for packaging. As a result, container transportation has the advantages of reducing the time and expense and being a convenient means of freight transportation.

Containers used in such container-based transportation should have a design that prevents accidents, such as the damage, loss and theft of freight, which may occur during transportation.

FIG. 1 is showing an ordinary container door locking apparatus actually installed on a container door.

As shown in FIG. 1, a conventional container door locking apparatus includes a door locking rod attached onto a container door at a predetermined location and configured to fasten a container body and the container door together, and a lock handle configured to extend in the direction perpendicular to the longitudinal direction of the door locking rod and to rotate and thereby move the door locking rod.

Furthermore, a fastening device (not shown in FIG. 1) for fastening the lock handle, such as an electronic seal device, is provided.

Accordingly, in order to open the door to the container, the fastening device of the container door locking apparatus is unlocked, the door locking rod is moved by rotating the lock handle, and then the container door is opened.

Meanwhile, since such a container door is opened illegitimately using various methods, such as a method of removing the fastening device of a container door locking apparatus illegitimately by cutting it, a method of preventing the illegitimate opening of a container has been being actively researched.

Meanwhile, the conventional fastening device of such a container door locking apparatus should be normally locked and unlocked under ensured security, which causes inconvenience because a reader capable of communicating with the conventional fastening device should be carried and used whenever the conventional fastening device is to be locked or unlocked. Furthermore, when many containers are locked or unlocked, inconvenience is caused because respective readers have to be prepared beforehand so that the fastening devices of the containers can be locked and unlocked.

### SUMMARY

Accordingly, the present invention has been made keeping in mind the above problems occurring in the prior art, and an object of the present invention is to provide a container electronic seal device, which allows external memory storing at least one security authentication file including a password to be inserted and connected and selectively performs normal locking and normal unlocking depending on whether the security authentication file of the external memory is normal, and a method of operating the container electronic seal device.

In order to accomplish the above object, the present invention provides a container electronic seal device which can be selectively locked and unlocked using external memory, the container electronic seal device being installed on a door locking rod and a lock handle provided in a container door, the device comprising a body unit disposed around part of the door locking rod and part of the lock handle, and provided with a through hole through which the door locking rod passes, a guide opening which extends from the through hole along a longitudinal direction so that the lock handle is inserted to and moves along the guide opening, and an access port configured such that detachable external memory is inserted thereto; a locking arm unit provided across upper and lower ends of the body unit, and configured to rotate and fasten, by a locking arm, the lock handle inserted into the guide opening of the body unit; and an electronic parts unit contained in the body unit, and configured to selectively perform locking and unlocking depending on whether a security authentication file of the external memory connected through the access port of the body unit is normal and to monitor illegitimate opening by checking whether the locking arm unit is open; wherein the container electronic seal device is selectively locked and unlocked using the external memory which is inserted into the access port of the body unit and which stores the security authentication file issued using an identification number of the electronic seal device.

In order to accomplish the above object, the present invention provides a method of operating a container electronic seal device which can be selectively locked and unlocked using external memory, the container electronic seal device being installed on a door locking rod and a lock handle provided in a container door, the method including detecting whether a locking arm unit for fastening the lock handle has been closed; detecting connection of the external memory; checking whether a security authentication file of the connected external memory is normal; performing normal locking depending on whether the security authentication file of the external memory is normal; detecting reconnection of the external memory; checking whether a security authentication file of the reconnected external memory is normal; and performing normal unlocking depending on whether the security authentication file of the reconnected external memory is normal.

The security authentication file may be issued by a server using an identification number of the electronic seal device, and a user may access the server, undergo user authentication and then download the security authentication file from the server to the external memory.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of the state of a container door and a container door locking apparatus which shows the location where a container electronic seal device which can be selectively locked and unlocked using external memory according to the present invention is installed;

FIG. 2A is a perspective view of the container electronic seal device which can be selectively locked and unlocked using external memory according to the present invention;

FIG. 2B is a diagram showing the state in which the container electronic seal device which can be selectively locked and unlocked using external memory according to the present invention, which is installed on the door locking rod 21 and lock handle 22 of the container door 11, is unlocked;

FIG. 2C is a diagram showing the state in which the container electronic seal device which can be selectively locked and unlocked using external memory according to the present invention, which is installed on the door locking rod and lock handle of the container door, is locked;

FIG. 3 is a diagram showing the detained configuration of the locking arm unit of the container electronic seal device 100 which can be selectively locked and unlocked using external memory according to the present invention;

FIG. 4 is a diagram showing the electronic parts unit of the container electronic seal device which can be selectively locked and unlocked using external memory according to the present invention; and

FIG. 5 is a flowchart of a method of operating the container electronic seal device which can be selectively locked and unlocked using external memory according to the present invention.

### DESCRIPTION OF THE PREFERRED EMBODIMENTS

Reference now should be made to the drawings, in which the same reference numerals are used throughout the different drawings to designate the same or similar components.

Preferred embodiments of the present invention will be described below in detail with reference to the accompanying drawings.

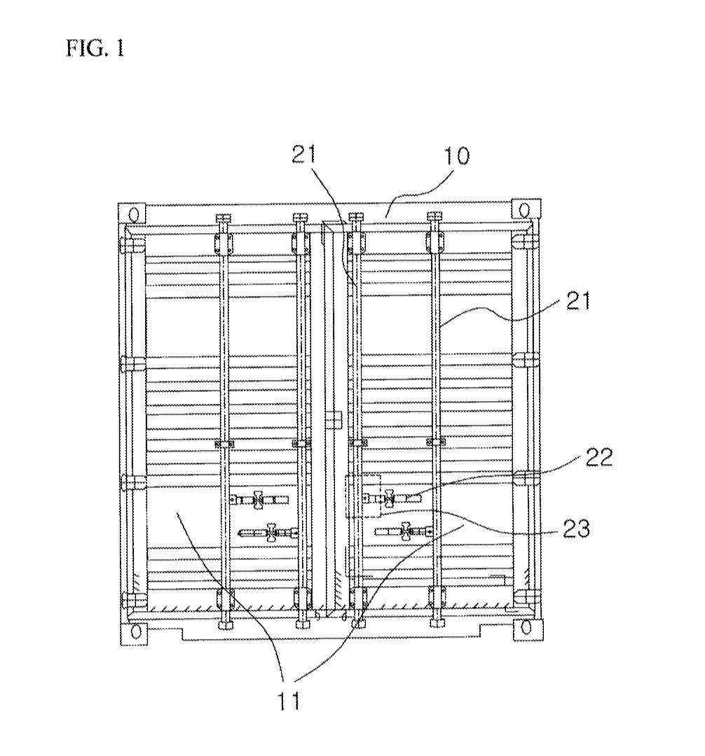

FIG. 1 is a diagram of the state of a container door and a container door locking apparatus which shows the location where a container electronic seal device which can be selectively locked and unlocked using external memory according to the present invention is installed.

The container electronic seal device which can be selectively locked and unlocked using external memory according to the present invention is installed at the location 23 where the door locking rod 21 and lock handle 22 of the container door locking apparatus are perpendicularly connected to each other. Accordingly, the container electronic seal device fastens the lock handle 22 of the container door locking apparatus and thus prevents the door locking rod 21 from moving, thus locking the container door locking apparatus.

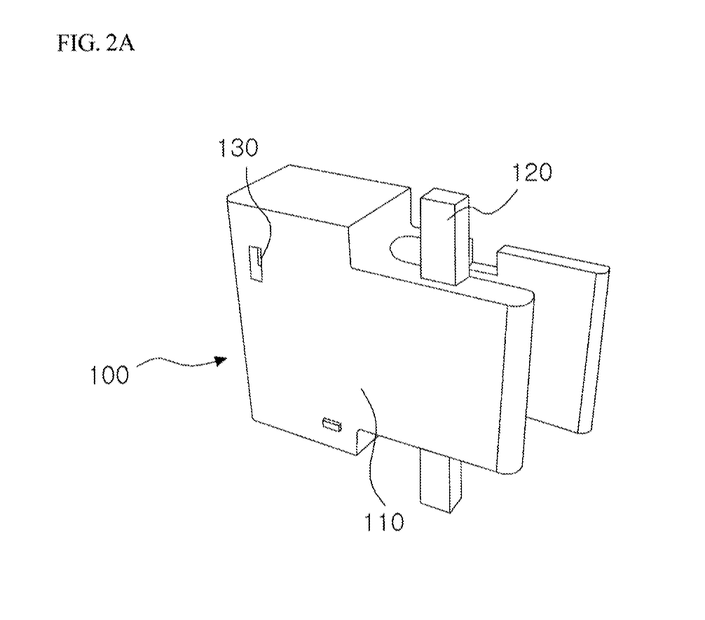

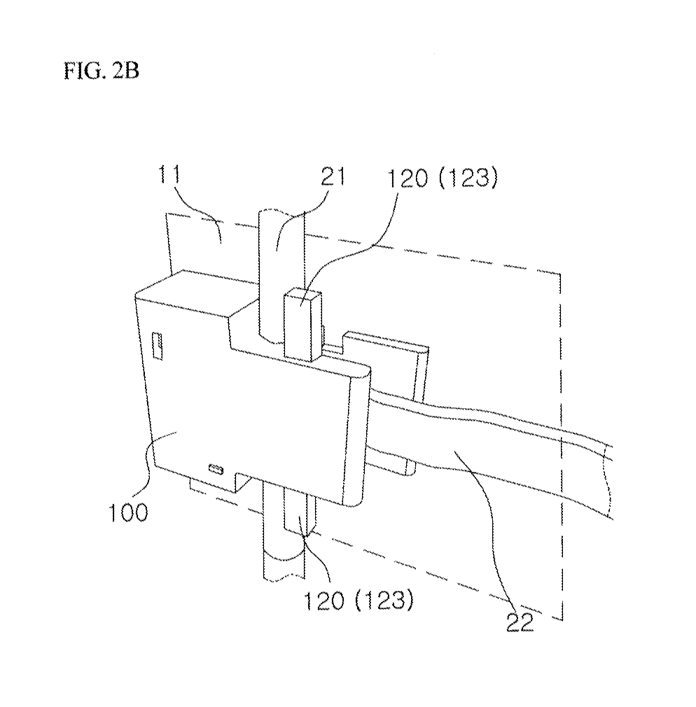

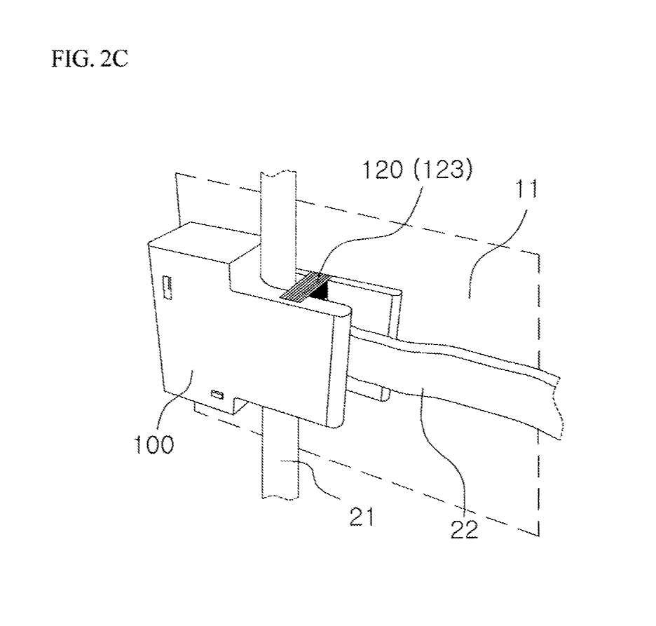

FIG. 2A is a perspective view of the container electronic seal device which can be selectively locked and unlocked using external memory according to the present invention, FIG. 2B is a diagram showing the state in which the container electronic seal device which can be selectively locked and unlocked using external memory according to the present invention, which is installed on the door locking rod 21 and lock handle 22 of the container door 11, is unlocked, and FIG. 2C is a diagram showing the state in which the container electronic seal device which can be selectively locked and unlocked using external memory according to the present invention, which is installed on the door locking rod 21 and lock handle 22 of the container door 11, is locked.

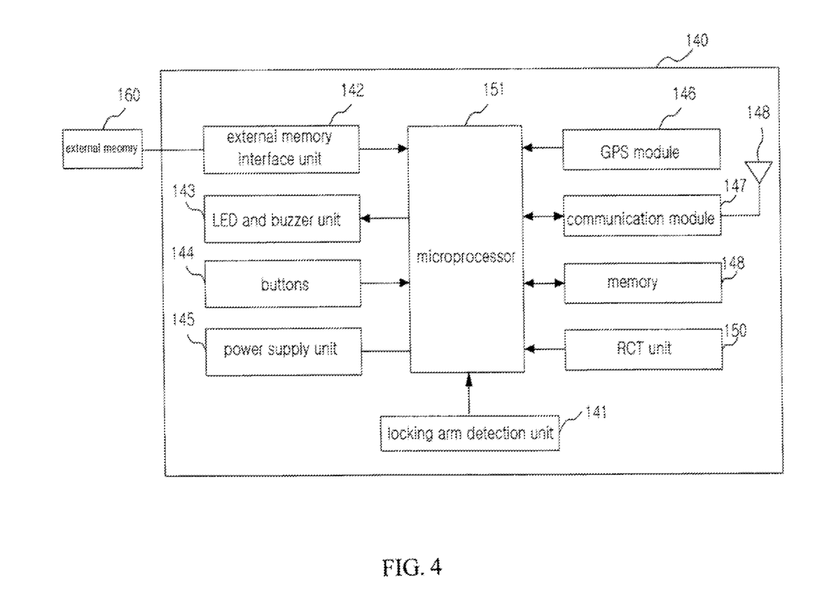

The container electronic seal device 100 which can be selectively locked and unlocked using external memory according to the present invention is an electronic seal device which is attached to the door locking rod 21 and the lock handle 22 provided on the container door 11, and detects the illegitimate opening of the container. The container electronic seal device 100 includes a body unit 110 disposed around part of the door locking rod 21 and part of the lock handle 22 at the location 23 where the door locking rod 21 and the lock handle 21 are connected to each other, and provided with a through hole through which the door locking rod 21 passes, a guide opening which extends from the through hole in the longitudinal direction so that the lock handle 22 is inserted to and moves along the guide opening, and an access port 130 configured such that external memory can be selectively attached thereto and detached therefrom, a locking arm unit 120 provided across the upper and lower ends of the body unit 130, and configured to rotate and fasten, by a locking arm 123, the lock handle 22 inserted into the guide opening of the body unit 130, and an electronic parts unit 140 (not shown in FIG. 2A) contained in the body unit 130, and configured to selectively perform locking and unlocking depending on whether a security authentication file of the external memory connected through the access port of the body unit 130 is normal and to monitor illegitimate opening by checking whether the locking arm unit 120 is opened. Here, the container electronic seal device is selectively locked and unlocked using the external memory (160 of FIG. 4) which is connected to the access port of the body unit 110 and which stores a security authentication file issued using the identification number of the electronic seal device.

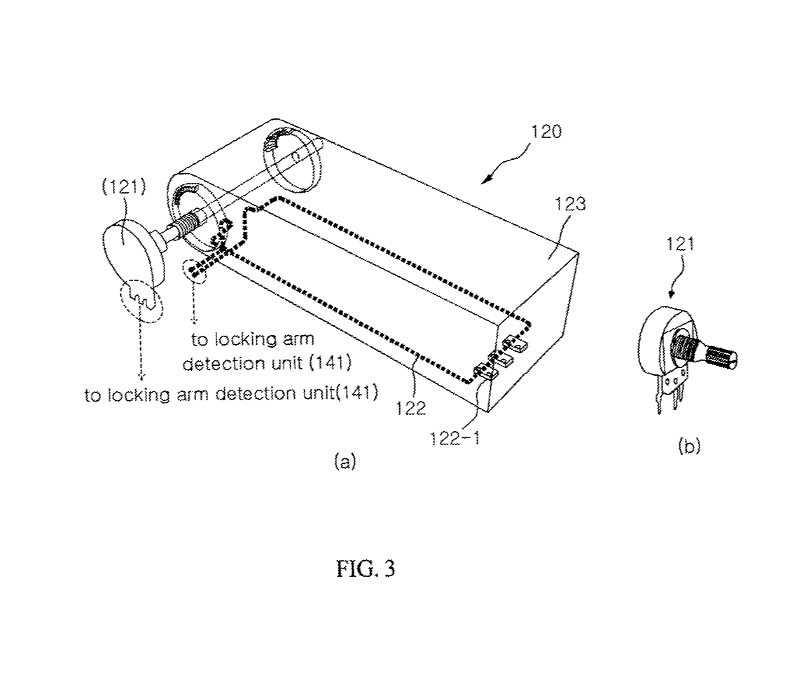

FIG. 3 is a diagram showing the detained configuration of the locking arm unit 120 of the container electronic seal device 100 which can be selectively locked and unlocked using external memory. FIG. 3(a) is a perspective view of the locking arm unit, and FIG. 3(b) is a perspective view showing a rotary variable resistor provided in the locking arm unit. Detailed descriptions thereof will be given later.

FIG. 4 is a block diagram of the electronic parts unit 140.

The electronic parts unit 140 includes a locking arm detection unit 141 for monitoring whether the locking arm unit 120 is opened by detecting the variation in the rotary variable resistor 121 of the locking arm unit 120 and detecting whether electric signal is flowing through the wiring 122 in the locking arm 123, an external memory interface unit 142 for interfacing with the external memory 160 connected to the access port of the body unit 110, and a microprocessor 151 for determining whether a security authentication file of the connected external memory 160 is normal and then performing normal locking and unlocking, and monitoring illegitimate opening by monitoring whether the locking arm unit 120 is opened according to the detection result of the locking arm detection unit 141.

If it is determined that the locking arm unit 120 is illegitimately opened, the microprocessor 151 immediately sends an alarm signal to a server and stores illegitimate opening-related information.

The microprocessor 151, after performing the normal locking, switches to active mode and monitors whether the electronic seal device has been illegitimately opened, and, after performing the normal unlocking, switches to sleep mode and supplies power only to the microprocessor 151, the locking arm detection unit 141, and the external memory interface unit 142.

The electronic parts unit 140 further includes a power supply unit 145 configured to supply power and to be charged with electricity again, an LED/buzzer unit 143 for indicating the battery level of the power supply unit 145 and outputting an alarm when the electronic seal device is illegitimately opened, buttons 144 for manually operating the LED/buzzer unit 143, a Global Positioning Satellite (GPS) module 146 for providing the value of real-time location of the electronic seal device received from a GPS device, a communication module 147 for communicating with the server related to an antenna 148, memory 149 for storing history data about the locking, illegitimate opening and unlocking of the electronic seal device and system data used for the basic operation of the electronic seal device, and a Real Time Clock (RTC) unit 150 for providing real-time information including time data.

The history data includes the identification number of the electronic seal device, time, a locking and unlocking state, information about illegitimate manipulation, and the value of the location of the electronic seal device.

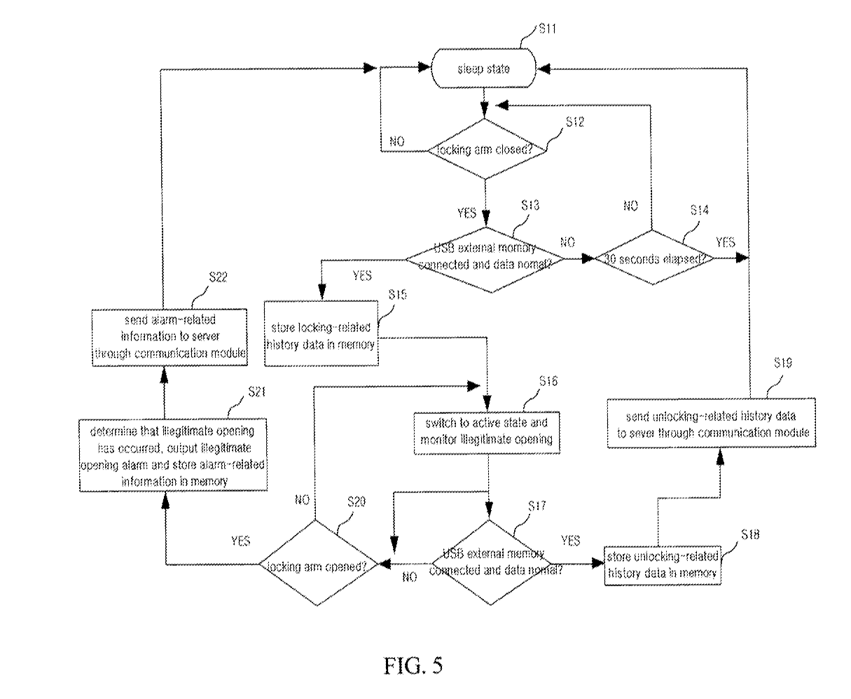

FIG. 5 is a flowchart of a method of operating the container electronic seal device which can be selectively locked and unlocked using external memory according to the present invention.

The method of operating the container electronic seal device which can be selectively locked and unlocked using external memory according to the present invention includes steps S11 and S12 for detecting whether the locking arm unit 120 has been closed, a step S13 for detecting the connection of the external memory 160, steps S13 and S14 for checking whether a security authentication file of the connected external memory 160 is normal, a step S15 for performing normal locking depending on whether the security authentication file of the external memory is normal, a step S17 of detecting the reconnection of the external memory, a step S17 of checking whether a security authentication file of the reconnected external memory is normal, and steps S17, S18 and S19 for performing normal unlocking depending on whether the security authentication file of the reconnected external memory is normal.

The method further includes, after the step of performing the normal locking, steps S16, S17, and S20 to S22 of monitoring illegitimate opening.

The container electronic seal device which can be selectively locked and unlocked using the above-described external memory according to the present invention and the method of operating the container electronic seal device using the above-described external memory according to the present invention will be described in detail below.

First, the electronic seal device 100 according to the present invention is installed at the location 23 where the door locking rod 21 and lock handle 22 of the container door 11 are connected to each other, as shown in FIG. 2B.

The lock handle 22 is fastened by manipulating the locking arm unit 120 in the state in which the door locking rod 21 has been passed through the through hole formed in the body unit 110 of the electronic seal device 100 and the lock handle 22 has been inserted into the guide opening of the body unit 110, as shown in FIG. 2C.

Here, the locking arm unit 120 will now be described in detail.

As shown in FIG. 3, the locking arm unit 120 is connected to the upper and lower ends of the body unit 110 of the electronic seal device 100, and selectively closes and opens the guide opening of the body unit 110, by rotating of a locking arm 123. The reference number 122-1 identifies ground points. The rotary variable resistor 121, the resistance value of which varies depending on the angle of the rotation of the locking arm 123 in the locking arm unit 120 is provided in the head portion of the locking arm unit 120 connected to the upper end of the body unit 110. When the locking arm unit 120 has been opened (when the locking arm 123 is located in horizontal direction), as shown in FIG. 2B, the resistance value of the rotary variable resistor 121 falls within a range of 800-900Ω. In contrast, when the locking arm unit 120 has been closed (when the locking arm 123 is located in vertical direction), as shown in FIG. 2C, the resistance value of the rotary variable resistor 121 falls within a range of 100-200Ω.

Accordingly, when the locking arm detection unit 141 provided in the electronic parts unit 140 of the electronic seal device 100 detects the resistance value of the rotary variable resistor 121 of the locking arm unit 120, the microprocessor 151 determines that the locking arm unit 120 has been opened (the lock handle 22 is not fastened) if the resistance value falls within the range of 800-900Ω, and determines that the locking arm unit 120 has been closed (the lock handle 22 has been fastened) if the resistance value falls within the range of 100-200Ω.

Furthermore, as shown in FIG. 3, wiring 122 is provided from the header portion of the locking arm unit 120 to the end thereof. Accordingly, in a normal state in which the locking arm unit 120 is not cut, an electric signal flows through the wiring. Accordingly, the locking arm detection unit 141 may determine whether coercive cutting has occurred by detecting whether an electric signal is flowing through the wiring of the locking arm unit 120. If no electric signal is flowing through the wiring, it is determined that the locking arm unit 120 has been coercively cut.

Now, the method of operating the container electronic seal device which can be selectively locked and unlocked using external memory will be described with reference to FIG. 5.

First, a user stores a security authentication file including a password, which can be used to normally lock or unlock the container electronic seal device 100, in the external memory 160. The external memory 160 comprises any one of a USB dist, a memory card and a portable memory chip.

That is, a user connects the external memory 160 to a separate external device, accesses a specific server (a security authentication file management server, such as the server of a customs administration office) using the external device, undergoes user authentication, and downloads a security authentication file corresponding to the identification number of the electronic seal device to the external memory 160. The specific server issues a security authentication file for the locking and unlocking of the electronic seal device using the identification number of the electronic seal device, and the security authentication file is encrypted using a password or a secret key. The specific server issues security authentication files, and may collect a specific amount of money for each of the security authentication files.

Thereafter, a user installs the initially locked electronic seal device 100 on the container 10, switches the locking arm unit 120 to a lock state, inserts and connects the external memory 160 into the electronic seal device 100, and causes the data (for example, a security authentication file) of the external memory 160 to be read. If the read security authentication file is normal, the electronic seal device 100 is normally locked. After the electronic seal device 100 has been normally locked, the electronic seal device 100 monitors illegitimate opening, and communicates with the server.

Furthermore, in a normal locked state, the external memory 160 is inserted into and connected to the electronic seal device 100, data (for example, the security authentication file) is read from the external memory 160, and normal unlocking is performed if the read data is normal.

The method of operating the electronic seal device 100 will now be described in greater detail.

The initially unlocked electronic seal device 100 is installed on the container door 11 at the predetermined location 23. The initially unlocked electronic seal device 100 operates in sleep mode so as to reduce power consumption. That is, at step S11, power is supplied only to the microprocessor 151, the locking arm detection unit 141 and the external memory interface unit 142 and the supply of power to the other elements is cut off.

A user switches the locking arm unit 120 to a locked state by manipulating the locking arm 123 of the locking arm unit 120. The electronic parts unit 140 of the electronic seal device 100 detects whether the locking arm unit 120 has been closed at step S12.

The electronic parts unit 140 detects whether the external memory 160 is inserted and connected. If it is determined that the external memory 160 has been inserted and connected at step S13, the security authentication file is read from the inserted external memory 160 and it is determined whether the security authentication file is normal. If the security authentication file, including a password corresponding to the identification number of the electronic seal device 100, is normal, history data related to the normal locking of the electronic seal device 100 is stored in the memory 149 and then normal locking is performed at step S15. After the normal locking has been performed, the external memory 160 is detached.

After the normal locking has been performed, the electronic seal device 100 switches to active mode and then monitors the illegitimate opening of the locking arm unit 120 at step S16.

If the reconnection of the external memory 160 is detected, the security authentication file of the reconnected external memory 160 is read and the normality of the security authentication file is checked at step S17.

If the security authentication file of the external memory 160 is normal, the electronic parts unit 140 stores history data related to the unlocking, performs the normal unlocking of the electronic seal device 100, and then send the history data related to the unlocking to the server using the communication module 147 at steps S18 and S19. Thereafter, the electronic seal device 100 switches to sleep mode.

As described above, the present invention has the advantage of enabling locking and unlocking to be performed conveniently and easily because the normal locking and unlocking of the electronic seal device 100 is performed using the external memory in which the security authentication file was stored.

Meanwhile, if the security authentication file of an external memory 160 reconnected after the normal locking is not normal but the locking arm unit 120 is not opened, the electronic parts unit 140 determines that illegitimate opening has not occurred and then continuously monitors illegitimate opening at steps S17, S20 and S16.

However, if the security authentication file of an external memory 160 reconnected after the normal locking is not normal and the locking arm unit 120 is opened, or if, even when the external memory 160 has not been reconnected, the locking arm unit 120 has been opened (for example, the resistance value of the variable resistor falls within a range of 100-200Ω) or the locking arm unit 120 has been coercively cut (for example the wiring has been cut, so that no electric signal is flowing through it), it is determined that illegitimate opening has occurred, illegitimate opening-related history data (including the identification number of the electronic seal device, the time, information about an illegitimate opening state, and the value of the location of the electronic seal device) is stored, and an illegitimate opening alarm signal is immediately sent to the server at steps S20, S21 and S22.

As described above, the present invention is configured not only to perform the locking and unlocking of the electronic seal device using the external memory but also to monitor the illegitimate opening of the locking arm unit and provide an illegitimate opening alarm signal to the server immediately when illegitimate opening has occurred.

The present invention has the advantage of conveniently locking and unlocking the electronic seal device without requiring the help of expensive equipment (that is, an expensive portable reader) because the external memory storing a security authentication file including a password is inserted and connected and the container electronic seal device is normally locked or unlocked depending on whether the security authentication file of the external memory is normal.

Furthermore, the present invention has the advantage of being able to lock and unlock the electronic seal devices of a plurality of containers using only a single piece of external memory after a plurality of security authentication files has been stored in the single piece of external memory.

The present invention has the advantage of allowing countermeasures to be rapidly taken when a container door is illegitimately opened because the present invention is configured to monitor illegitimate opening by, in the state in which the container electronic seal device has been normally locked, determining whether the security authentication file of the inserted and connected external memory is normal and monitoring the opening of the locking arm unit in such a way as to detect a variation in the variable resistor of the locking arm unit which fastens the lock handle of the container door locking apparatus, and is configured to immediately send an alarm signal to the server if it is determined that illegitimate opening has occurred.

Moreover, the present invention has the advantage of minimizing power consumption because, after normal locking using the external memory, the container electronic seal device operates in active mode in which power is supplied to all the components of the container electronic seal device and, after normal unlocking using the external memory, power is supplied only to the microprocessor, the locking arm and the external memory interface unit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A container electronic seal device which can be selectively locked and unlocked using external memory, the container electronic seal device being installed on a door locking rod and a lock handle provided in a container door, the device comprising:
a body unit disposed around part of the door locking rod and part of the lock handle, and provided with a through hole through which the door locking rod passes, a guide opening which extends from the through hole along a longitudinal direction so that the lock handle is inserted to and moves along the guide opening, and an access port configured such that detachable external memory is inserted thereto;
a locking arm unit provided across upper and lower ends of the body unit, and configured to rotate and fasten, by a locking arm, the lock handle inserted into the guide opening of the body unit; and
an electronic parts unit contained in the body unit, and configured to selectively perform locking and unlocking depending on whether a security authentication file of the external memory connected through the access port of the body unit is normal and to monitor illegitimate opening by checking whether the locking arm unit is open;
wherein the container electronic seal device is selectively locked and unlocked using the external memory which is inserted into the access port of the body unit and which stores the security authentication file issued using an identification number of the electronic seal device.

2. The container electronic seal device as set forth in claim 1, wherein the electronic parts unit comprises:
a locking arm detection unit for monitoring whether the locking arm unit is opened by detecting a variation in a variable resistor of the locking arm unit and detecting whether electric signal is flowing through a wiring in the locking arm;
an external memory interface unit for interfacing with the external memory connected to the access port of the body unit; and
a microprocessor for determining whether a security authentication file of the connected external memory is normal and then performing normal locking and unlocking, and monitoring illegitimate opening by monitoring whether the locking arm unit is opened based on a detection result of the locking arm detection unit.

3. The container electronic seal device as set forth in claim 2, wherein the microprocessor, after performing the normal locking, switches to active mode and monitors whether the electronic seal device is illegitimately opened, and, after performing the normal unlocking, switches to sleep mode and supplies power only to the microprocessor, the locking arm detection unit, and the external memory interface unit.

4. The container electronic seal device as set forth in claim 1, wherein the locking arm unit comprises:
a locking arm configured to rotate so as to fasten the locking handle inserted into the guide opening of the body unit;
a rotary variable resistor configured such that a resistance value thereof varies depending on an angle of rotation of the locking arm; and
wiring configured to allow an electric signal to flow therethrough so as to indicate whether coercive cutting has occurred.

5. The container electronic seal device as set forth in claim 1, wherein the external memory comprises any one of a USB dist, a memory card and a portable memory chip.

6. A method of operating a container electronic seal device which can be selectively locked and unlocked using external memory, the container electronic seal device being installed on a door locking rod and a lock handle provided in a container door, the method comprising:
detecting whether a locking arm unit for fastening the lock handle has been closed;
detecting connection of the external memory;
checking whether a security authentication file of the connected external memory is normal;
performing normal locking depending on whether the security authentication file of the external memory is normal;
detecting reconnection of the external memory;
checking whether a security authentication file of the reconnected external memory is normal; and
performing normal unlocking depending on whether the security authentication file of the reconnected external memory is normal.

7. The method as set forth in claim 6, wherein the detecting whether a locking arm unit for fastening the lock handle has been closed comprises detecting variation in a variable resistor provided in the locking arm unit.

8. The method as set forth in claim 6, further comprising, after the performing normal locking, monitoring illegitimate opening by checking whether the locking arm unit has been coercively cut.

9. The method as set forth in claim 6, wherein the security authentication file is issued by a server using an identification number of the electronic seal device, and a user accesses the server through a communication device, undergoes user authentication and then downloads the security authentication file from the server to the external memory through the communication device.
